(19) United States
(12) Patent Application Publication
(10) Pub. No.: US 2001/0035958 A1
(43) Pub. Date: Nov. 1, 2001

(54) Dual signal modulation scheme for eliminating non-linearity in a system

(76) Inventors: Michael K. Scruggs, Pompton Plains, NJ (US); Peter A. Wall, Bayonne, NJ (US); Ming-Hsing Yu, Wayne, NJ (US); Robert A. Kovacs, West Orange, NJ (US)

Correspondence Address: Loria B. Yeadon, Honeywell International Inc., 101 Columbia Road, Morristown, NJ, 07962, US

(21) Appl. No.: 09/810,140

(22) Filed: Mar. 16, 2001

Related U.S. Application Data
(60) Provisional application No. 60/190,663, filed on Mar. 20, 2000.

(51) Int. Cl. G01C 19/72

(52) U.S. Cl. 356/464

(57) ABSTRACT

A system for minimizing non-linearity in an Interferometric Fiber Optic Gyro (IFOG) that includes a light source, an Integrated Optics Chip (IOC) with first and second optical modulators, and a coupler to output an optical power signal corresponding to a rotation-induced phase shift in a fiber coil of the IFOG to processing electronics of the IFOG. The processing electronics include signal processing means to produce a digital signal corresponding to the optical power signal. A first digital-to-analog converter (DAC) receives the digital signal and provides a corresponding first modulation signal to the first optical modulator via a first amplifier. However, the first DAC and first optical modulator inherently introduce non-linearities into the first modulation signal. A second DAC receives the digital signal and provides a corresponding second modulation signal to the second optical modulator via a second amplifier. The second modulation signal drives the second optical modulator to compensate for the non-linearities in the first modulator signal.

### CROSS REFERENCE TO RELATED APPLICATION

This application claims the benefit of U.S. Provisional Application No. 60/190,663, filed Mar.20, 2000, and incorporated by reference herein.

### BACKGROUND OF THE INVENTION

1. Field of the Invention

The present invention relates to interferometric fiber optic gyros (IFOG), and more particularly to improving the total gyro linearity in an IFOG.

2. Description of the Related Art

There is a growing demand for high accuracy gyros for satellite pointing applications. In order to improve gyro precision, it is necessary to improve gyro linearity, especially at low angular rates. In typical satellite pointing applications, an interferometric fiber optic gyro (IFOG) is employed. In the IFOG, non-linearity arises from both the optical modulator characteristics and electrical non-linearity of the digital-to-analog converter. This non-linearity limits the ability to detect rotation rates near zero, a requirement for precise pointing applications.

A closed loop IFOG is illustrated in FIG. 1. An IFOG generally includes a light source 10, a coupler 20, an integrated optics chip (IOC) 30, and a fiber coil 40, which comprise the optical circuit 5. The fiber coil 40 provides the rotation-sensitive interferometer. The processing electronics 45 of the IFOG generally comprise a photodetector 50, an amplifier/filter 60, an analog-to-digital converter (A/D) 70, a digital signal processor (DSP) 80, a digital to analog converter (DAC) 90 and amplifier 95.

The processing electronics 45 function to provide a feedback phase shift in the optical circuit 5 which effectively compensates a rotation-induced phase shift sensed in the fiber coil 40. The magnitude of the feedback phase shift is an indication of the rotation rate. The photodetector 50 includes a photodiode 52 and an amplifier 54. The photodetector 50 converts an optical power output by optical coupler 20 to a corresponding voltage. The corresponding voltage is processed by amplifier/filter 60 and converted to a digital signal by A/D converter 70. A corresponding feedback signal is calculated in DSP 80, and fed back into the gyro via D/A converter 90 and amplifier 95.

In a typical IFOG of pointing grade quality, it is desirable to have a linear response to angular rates, particularly near zero. In a typical closed loop IFOG, the phase shift caused by angular rotation is nulled by the feedback phase shift (feedback signal). Typically the feedback signal provides a linear phase shift, commonly known as Ramp or Serrodyne Modulation. With Serrodyne modulation employed in a closed loop IFOG, the slope of the ramp will be proportional to the sensed rotation rate, thus, the frequency of the ramp and slope will vary with rotation rate. To minimize optical errors, the ramp retraces at a level corresponding to a multiple of 2π-phase shift. At rates near zero the ramp will have a very shallow slope. Under this condition, the IFOG output will exhibit non-linearities due to the electronic nonlinearity of the digital to analog converter (DAC) 90 used and the response of the optical modulator itself. At higher angular rates, the ramp slope increases to a point where the modulator and DAC 90 are cycled through a larger range, and effectively operate through the non-linearities. The IFOG output data is time averaged to minimize noise effects, with the non-linear effects canceling out at high angular rates.

Referring to FIG. 2, the feedback signal in the closed loop IFOG OF FIG. 1 is a retracing stair step signal. Each Stair “tread” is T/2, where T is the modulation period. When the feedback signal is applied to the phase modulator 32 in the IOC 30, the modulator 32 functions to apply a phase shift to the clockwise and counterclockwise light beams passing through the fiber coil, the phase shift being equal to a step change Δφ_{sagnac}. The Sagnac phase difference is calculated in radians using Equation 1 below:

$${Δφ}_{sagnac} = \frac{2 π DL}{λ c} Ω \qquad \text{Equation 1}$$

Where:

D is the fiber optic loop diameter,

L is the length of the fiber optic loop,

λ is the optical signal wavelength,

c is the speed of light, and

Ω is the loop rotation rate in radians/sec.

The gyro is nulled when the step change ΔNₛₜₑₚ is equal to the Sagnac phase difference Δφ_{sagnac}. Ideally, for a constant rotation rate, the feedback signal will produce a phase shift by generating a voltage to the IOC. The IOC and electronics can only operate over a finite range; therefore, the signal must be reset at a point in time where a discontinuity in the signal will not affect the output. This reset is chosen to correspond to 2π Modulation to have minimal effect on the gyro output signal. Non-linearities arise when the gyro rotation rates are very low and approach zero. Referring to FIG. 2, the IOC modulation waveform is displayed for a typical (moderate input rate condition). The slope of the ramp denoted Δφ_{Step} is the compensation signal in the closed loop gyro and the waveform repeats or retraces when the 2π reset voltage levels are attained. The non-linearity of the system is “averaged” since the electronics and IOC are exercised over the entire reset range at least once during the time period where the gyro output is computed. As the input rotation rate is reduced, the step size of the ramp Δφ_{Step} approaches zero, and the ramp frequency also becomes very low approaching zero. Under these conditions, the IOC and electronics non-linearities are not averaged since the IOC and electronics may operate over a very small range during the time where the gyro output is computed. The electronics is exercised over only a few fractions of a volt corresponding to a few BITS for the D to A converter. The gyro output is proportional to the step height Δφ_{Step} and with D to A electronics and IOC non-linearities (and in the presence of noise) the step height will not be monotonic (i.e. always increasing or decreasing with the corresponding increasing or decreasing input rotation rate). In this fashion, a Δφ_{Step} that is slightly larger or smaller than the previous step can be interpreted as a positive or negative rotation rate when ideally it should follow the input rotation rate. At input rates near zero, the D to A converter and IOC can hunt around in this fashion and no gyro output is produced for very small rates. Thus the IFOG can exhibit a non-linear or a “dead zone” response at low input rate.

However, variations in ΔN_{Step} affect the IFOG output. Therefore, a need exists for an alternate configuration of the processing electronics 45 to drive the optical modulator through a substantial range to minimize non-linearities.

It is therefore an object of the present invention to provide a modulation scheme for an IFOG that minimizes non-linearities.

### SUMMARY OF THE INVENTION

In accordance with our invention, processing electronics in an IFOG provide dual modulation to minimize non-linearities. The aforementioned limitations of the signal processing electronics and IOC can be eliminated near zero rate by the addition of a second D to A converter, drive amplifier and IOC input. The IFOG operates as discussed previously, however, DSP 80 operates in conjunction with the second D to A converter and its drive amplifier 97 to produce an electronic rate signal that is in addition to the sensed rotation rate. In this condition, at zero rotation rate, the IFOG loop responds to the “electrical rate”. The electrical rate is chosen so that Δφ_{Step} is large enough to operate through the system non-linearities (a condition corresponding to moderate input rates) and the DSP processor is adjusted so that the electronically induced rate is removed from the gyro output signal.

### BRIEF DESCRIPTION OF THE DRAWINGS

The above and other objects, features, and advantages of the present invention will become more apparent in light of the following detailed description of an exemplary embodiment thereof taken in conjunction with the attached drawings in which:

FIG. 1 is a block diagram illustrating a conventional IFOG;

FIG. 2 is a diagram illustrating a typical feedback signal applied to the phase modulator; and

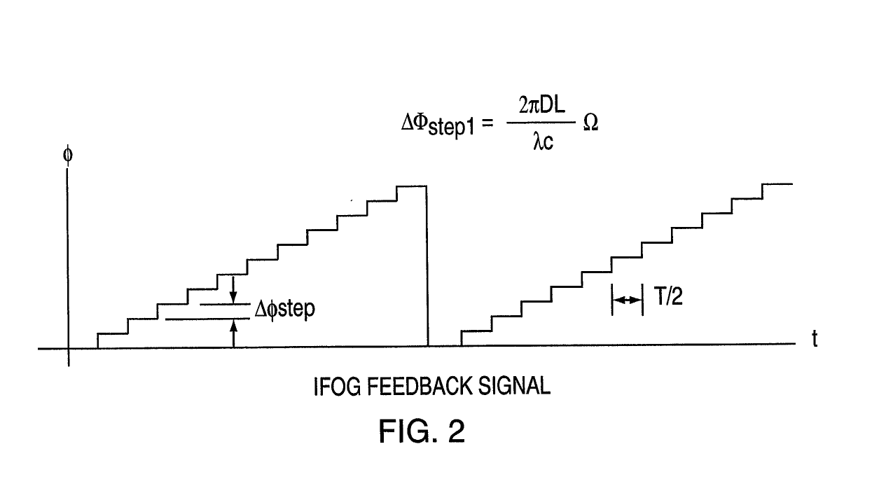

FIG. 3 is a block diagram of an illustrative embodiment of an IFOG having processing electronics in accordance with the present invention.

### DETAILED DESCRIPTION

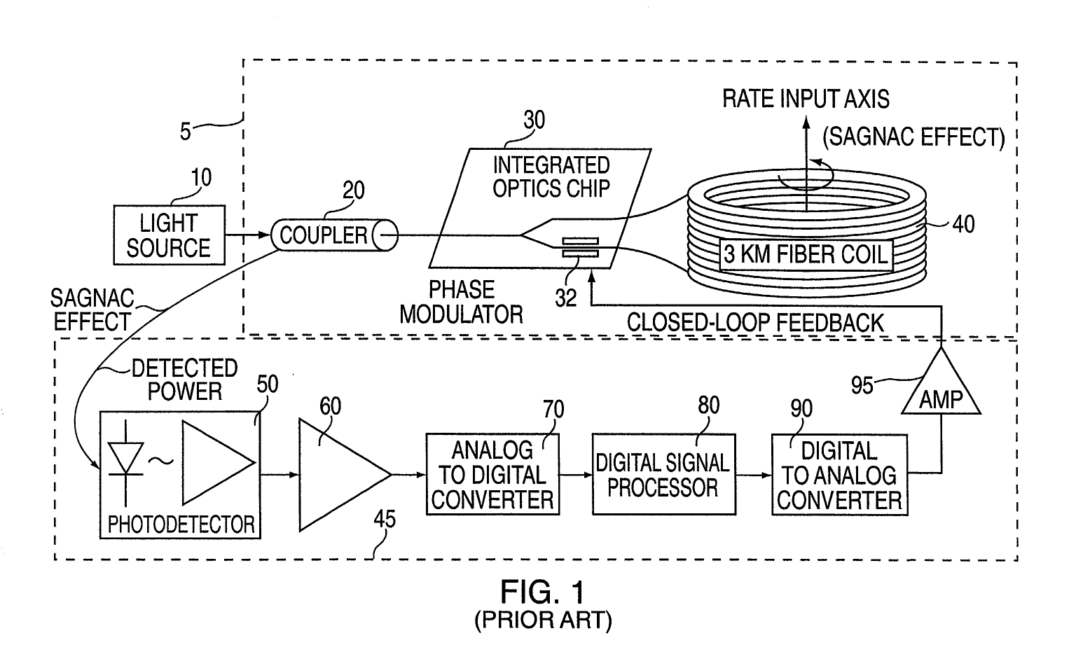

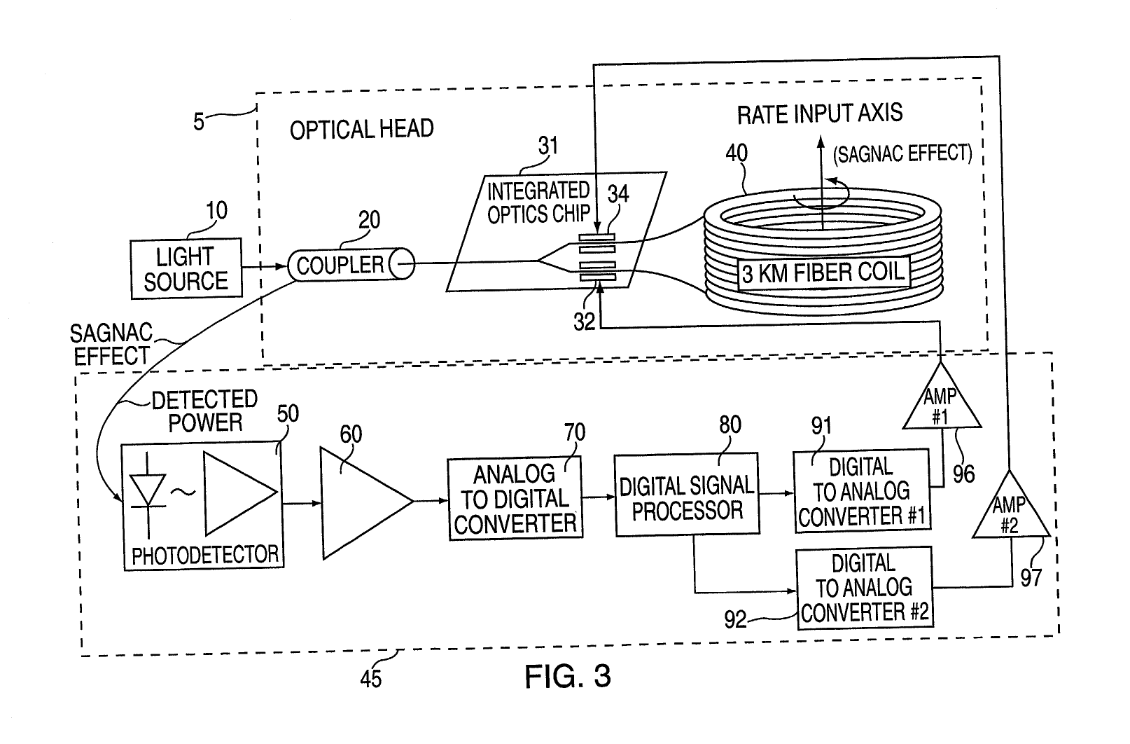

Turning to the drawings, FIG. 3 illustrates an IFOG in accordance with the present invention. The integrated optics chip 30 of the prior art gyro of FIG. 1 has been replaced with an IOC 31 having two phase modulators 32 and 34. Further the digital to analog converter 90 and its associated amplifier 95 of the prior art gyro of FIG. 1 have been replaced by a first digital to analog converter 91 and associated amplifier 96 connected to the modulator 32 and a second digital to analog converter 92 and its associated amplifier 97 connected to the modulator 34 of the IOC 31.

The signals generated by the DSP 80 drive both DAC #1 91 and DAC #2 92. DAC #2 92 acts as a signal generator input to the IFOG. That is, DAC #2 92 generates a waveform driving the second optical modulator 34 to adjust the optical signal to thereby drive the optical modulator 34 and DAC #1 91 through a substantial range to minimize non-linearities. The waveform generated by DAC #2 92 may be optimized to take any shape. The waveform may be, for example, sinusoidal, triangular, ramp, or random. Ideally the waveform has a zero average value so the artificial rate introduced by DAC #2 92, via the optical modulator, will have no affect on IFOG performance. Alternatively, if the signal has a non-zero average value, it may be compensated for within the processing electronics.

Accordingly, the addition of DAC #2 92 provides the necessary driving capabilities to adjust for non-linearities in the feedback signal.

While the present invention has been shown and described in detail with reference to one specific illustrative embodiment, it is to be clearly understood that many variations may be made by anyone having ordinary skill in the art while staying within the scope and spirit of the present invention as defined by the appended claims.

What is claimed is:

1. An interferometric fiber optic gyro comprising
a light source,
integrated optics including a first and a second optical modulator,
a fiber coil,
processing electronics, and
a coupler to output an optical power signal corresponding to a rotation induced phase shift in said fiber coil to said processing electronics, said processing electronics including
signal processing means to produce a digital signal corresponding to the optical power signal,
a first digital to analog converter that receives said digital signal and provides a corresponding first modulation signal to said first optical modulator, said first converter and said first optical modulator inherently introducing non-linearities into said first modulation signal, and
a second digital to analog converter that receives said digital signal and provides a corresponding second modulation signal to said second optical modulator, said second modulation signal driving said second optical modulator to compensate for said non-linearities in said first modulation signal.

2. The gyro of claim 1, wherein the second modulation signal has a zero average value.

3. The gyro of claim 1, wherein the second modulation signal has a non-zero average value, said non-zero average value being compensated for by the digital signal processor.

4. The gyro of claim 1, wherein the second modulation signal is sinusoidal.

5. The gyro of claim 1, wherein the second modulation signal is a triangular waveform.

6. The gyro of claim 1, wherein the second modulation signal is a ramp signal.

7. The gyro of claim 1, wherein the second modulation signal is a random signal.

8. A method for minimizing non-linearity in an Interferometric Fiber Optic Gyro (IFOG), said IFOG including a light source, an Integrated Optics Chip (IOC) with first and second optical modulators, and a coupler to output an optical power signal corresponding to a rotation-induced phase shift in a fiber coil of the IFOG to processing electronics of the IFOG, said method comprising the steps of:
producing a digital signal corresponding to the optical power signal;
driving the first optical modulator with a first modulation signal, corresponding to the digital signal, the first modulation signal produced via a first digital-to-analog converter (DAC) and a first amplifier, said first DAC and first optical modulator inherently introducing non-linearities into the first modulation signal; and
driving the second optical modulator with a second modulation signal corresponding to the digital signal, the second modulation signal produced via a second DAC and a second amplifier, to compensate for non-linearities in the first modulator signal.

9. The method recited in claim 8, wherein the second modulation signal has a zero average value.

10. The method recited in claim 8, wherein the second modulation signal has a non-zero average value, the method further comprising the step of compensating for the non-zero average value via a digital signal processor.

11. The method recited in claim 8, wherein the second modulation signal is sinusoidal.

12. The method recited in claim 8, wherein the second modulation signal is a triangular waveform.

13. The method recited in claim 8, wherein the second modulation signal is a ramp signal.

14. The method recited in claim 8, wherein the second modulation signal is a random signal.
